(19) United States
(12) Patent Application Publication
(10) Pub. No.: US 2015/0192180 A1
(43) Pub. Date: Jul. 9, 2015

(54) DISC BRAKE AND A HOLD-DOWN SPRING FOR SUCH BRAKE

(71) Applicant: WABCO Radbremsen GmbH, Mannheim (DE)

(72) Inventor: Eugen Kloos, Zwingenberg (DE)

(21) Appl. No.: 14/417,545

(22) PCT Filed: Dec. 2, 2013
(86) PCT No.: PCT/EP2013/003631

§ 371 Date: Jan. 26, 2015

(30) Foreign Application Priority Data
Dec. 5, 2012 (DE) 10 2012 023 813.4

(51) Int. Cl. F16D 65/095; F16D 55/225; F16D 65/00

(52) U.S. Cl. CPC F16D 65/095; F16D 65/0068; F16D 55/225; F16D 2055/0016

(57) ABSTRACT

The invention relates to a disc brake comprising a pressing device that is pressed against a brake disc in order to brake, a hold-down spring (30) in the form of a leaf spring that holds down the pressing device and a hold-down bracket which comprises two rods (34, 36) and preloads said hold-down spring against the pressing device, said hold-down spring being designed to be symmetrical with respect to its transverse plane and comprising two spring legs and a central region between two spring legs which extends radially outwards (form-fittingly) between the two rods of the hold-down bracket, the two spring legs each having an opening into which one projection in each case extends on the pressing device, said spring legs each comprising a first region on which one rod (34, 36) of the hold-down bracket lies so as to hold down same, and a second region (56, 58) which lies against the pressing device so as to hold down same, said first regions of the spring legs being held at a distance from the pressing device when in the resting state, and the spring legs initially extending radially outwards from the first region towards the second region.

### CROSS REFERENCE TO RELATED APPLICATION

The present application is a 35 U.S.C. §371 national phase entry application of, and claims priority to, International Patent Application No. PCT/EP2013/003631, filed Dec. 2, 2013, which claims priority to German Patent Application No. DE 10 2012 023 813.4, filed Dec. 5, 2012, the disclosures of which are hereby incorporated by reference in their entirety for all purposes.

### BACKGROUND

The invention relates to a disk brake, in particular for commercial vehicles, comprising a pressing device, which is pressed against a brake disk for braking, a hold-down spring in the form of a leaf spring, which holds down the pressing device, and a hold-down bracket, which comprises two rods and preloads the hold-down spring against the pressing device, wherein the hold-down spring is designed symmetrically with respect to the transverse plane thereof and comprises two spring legs and a central region (that is symmetrical with respect with respect to the transverse plane) between the two spring legs, which extends radially outward (in a form-locked manner) between the two rods of the hold-down bracket, the two spring legs have a respective opening into which in each case a projection extends on the pressing device, the spring legs each have a first region, against which a respective rod of the hold-down bracket rests in a hold-down manner, and a second region, which rests against the pressing device in a hold-down manner, and the first regions of the spring legs are held at a distance from the pressing device in the rest state.

Such a disk brake is known from DE 10 2006 023 964 B3, for example. Reference is made to EP 694 707 B3 and to German patent application 110 2011 115 304 of Sep. 29, 2011 with respect to the prior art.

DE 698 16 175 T2 shows a disk brake in which a spring, which is stretched in the unloaded state, is attached to the backing plate of a brake pad by placing corresponding openings of the spring over tabs and by supporting the outer edges of the openings in grooves of the tabs. This gives the spring an overall shape that tensioned in a curved manner, Due to the inner elasticity of the spring, it is supported both in the grooves and radially outwardly on the tabs. If a hold-down bracket is applied from the radial outside in detent sections, the spring is seated, in a hold-down manner, against regions of the backing plate that are located between the tabs or the openings and the detent sections. The spring is not seated against the backing plate in a hold-down manner on the other side of the tabs or openings, but only in the aforementioned groove and in a manner that is directed radially outwardly, because the elastic restoring force thereof acts in this direction.

In corresponding disk brakes, the backing plate, the hold-down bracket and the hold-down spring are generally designed in each case symmetrically with respect to the center plane thereof. In this way, faulty installation and mix-ups are avoided.

According to the invention, the pressing device can be not only a brake pad comprising a backing plate and a friction lining, but also a pressure plate or pressure distribution plate, which is designed to be flexurally rigid, so as to ensure pressure distribution across the largest possible surface area of the backing plate, also with respect to the backing plate not being designed excessively thick, and therefore not sufficiently flexurally rigid.

A rest state according to the invention shall be understood to mean a state in which the brake disk is stationary and the brake is not actuated. Since the hold-down bracket exerts a preload on the hold-down spring, the hold-down spring is subject to partial load in the aforementioned rest state.

A disk brake that is provided with a pad mount uses hold-down springs in each case to position the two brake pads (composed of the friction lining and metal backing plate) that are disposed on either side of the brake disk in shaft guides of the brake caliper or brake carrier, wherein the respective hold-down spring is mounted in a longitudinally extending manner on an upper edge region of the brake pad which faces an installation opening of the brake caliper. The spring is held under preload by way of a hold-down bracket that stretches across the installation opening in the axial direction of the brake disk and that is attached to the brake caliper halves. The hold-down bracket thus runs transversely to the longitudinally extending hold-down spring. When the pads are installed and the spring is tensioned via the hold-down bracket, the hold-down spring is in the above-mentioned partial load range.

The brake pad is then mounted or supported radially inwardly and, via the lower edge regions provided on either side, in the guide shaft in the circumferential direction. The brake pad can be displaced axially (in both directions) in the shaft guide with the aid of a brake application device. The brake application device can be disposed in the brake caliper.

Since large brake pads having the corresponding weights are used in commercial vehicle disk brakes, primarily leaf springs are used for damping and positioning. The design of the leaf springs, which is to say the spring force to be applied by them, is done in accordance with the size and the weight of the respective brake pad. The contact area—this being the location for introducing the spring force onto the brake pad—is decisive for the functionality of the entire hold-down system. The durability of the hold-down spring is also of crucial importance, i.e., how it behaves under extreme conditions in field use over the service life thereof or over the pad replacement cycle thereof.

Disk brakes for commercial vehicles are frequently exposed to extreme conditions. This holds true for poor road sections, for example, where accelerations of up to 26 g occur. Under these conditions, the backing plate of the brake pad lifts off the lower and radially acting shaft guide and strikes radially outwardly against the hold-down spring. The state of the maximal radial deflection of the brake pad represents the full load state of the hold-down spring.

In conventional disk brakes, the second region of the leg spring, which is to say the region that is supposed to hold down the pressing device, lifts off radially outwardly in the full load state, so that no spring preload is present any longer. This gives rise to the risk of effective spring action being lost, among other things. Moreover, the spring may be impaired from frequent or rapidly consecutive occurrences of the full load range, which can result in deformations and destruction, for example.

If the hold-down spring, as a result of an accordingly offset attachment of the hold-down bracket, is disposed offset in the disk brake given the spring's form-locked connection to the hold-down bracket by means of the radial central region in the circumferential direction of the brake disk, so as to generate an additional tangential spring preload on the pressing device for radial spring preloading, additional shear and compressive strains occur in the disk brakes according to the prior art, which can result in material fatigue. This occurs in particular in the L-shaped transition region of the form-locked connection to the spring leg adjoining on this side.

It is the object of the invention to ensure optimal damping in disk brakes of the type mentioned above, and more particularly also in the fill load range and in continuous operation. This is to be done in particular without major intervention in the design of the disk brake, and more particularly by modifying only the hold-down spring, but not other components of the brake.

According to the invention, the stated object is achieved in a disk brake of the type mentioned above by the leg springs initially extending radially outwardly from the first region to the second region.

In this way it is ensured even in extreme situations and in the full load range that the second regions of the spring legs, which is to say those regions that exert the spring preload onto the pressing device, do not lift off. Deformation and destruction is thus prevented. The same applies to the above-described shear and compressive strains in the case of an eccentric arrangement of the hold-down spring.

According to a particularly preferred embodiment of the invention, it is provided that the hold-down spring surrounds the two rods of the hold-down bracket in each case in a trough-shaped manner, wherein the two first regions of the spring legs form the respective base of the trough. This ensures particularly reliable mounting of the hold-down spring, while also achieving the above-described object.

The trough is preferably not symmetrical. While the wall height of the trough on the side of the central region approximately corresponds to the diameter of the hold-down bracket, for example, it is lower on the side facing away from the central region, for example no more than half as high, so as to provide the spring leg, and in particular the free end thereof, with sufficient freedom of movement in keeping with the load case.

It is further preferably provided that the second regions in each case are located at least partially on the sides of the openings that face away from the first regions. In other words, they are located on the other side of the openings, as seen from the central region, which is to say in the end region of the two spring legs, whereby optimal lever action is achieved.

It is further preferably provided according to the invention that the openings are longer than the projections. It is thus ensured that the pressing device can adjust in the circumferential direction with respect to the hold-down spring, which can be advantage in certain operating situations for compensation.

According to a further preferred embodiment of the invention, the hold-down spring, when it is installed, is offset with respect to the pressing device in the circumferential direction of the brake disk.

This offset is advantageously implemented during forward travel in the disk exit direction.

According to the invention, the second regions of the two spring legs are further preferably located at the respective free end of the spring legs. In this way, optimal damping across the entire length of the spring leg is achieved. Moreover, they thus advantageously rest thereon close to the backing plate width.

As indicated above, it is further preferred according to the invention that the pressing device supported in a shaft radially inwardly and in the circumferential direction.

In addition to the disk brake described above in detail, the invention also creates a hold-down spring for such a disk brake, which is designed in particular to be used in the brake without further modifications to the disk brake itself. It is provided according to the invention for this purpose that the spring is designed symmetrically and comprises two spring legs as well as a central region between the two spring legs, which extends radially outwardly (in a form-locked manner between two rods of a hold-down bracket when the spring is installed, that the two spring legs have a respective opening into which in each case a projection extends on the pressing device when the spring is installed, the spring legs each comprise a first region, against which a respective rod of the hold-down bracket rests in a hold-down manner when installed, and a second region, which rests against the pressing device in a hold-down manner when installed, the first regions of the spring legs are held at a distance from the pressing device in the rest state when installed, and the spring legs initially extend radially outwardly from the first region to the second region.

According to the invention, it is preferably provided that the hold-down spring surrounds the two rods of the hold-down bracket in each case in a trough-shaped manner when the spring is installed, wherein the two first regions of the spring legs form the respective base of the trough.

It is further preferred according to the invention that the second regions are located at the respective end of the spring legs.

According to the invention, the second regions are further preferably located in each case at least partially on the sides of the opening which face away from the first regions.

Finally, it should be considered to be preferred according to the invention that the openings are longer than the projections.

The prior art, the problems arising from it, and the approach according to the invention are described in more detail hereafter with reference to the accompanying drawings. In the drawings:

### BRIEF DESCRIPTION OF THE DRAWINGS

FIG. 1 shows a top view onto a disk brake;

FIGS. 2 and 3 show axial partial views of a conventional disk brake with a centric installation position of a hold-down spring in the partial load or full load range;

FIGS. 4 and 5 show the same views as FIGS. 2 and 3, however of one exemplary embodiment of the invention;

FIGS. 6 and 7 show the same partial views of a conventional disk brake as in FIGS. 2 and 3, however with a hold-down bracket offset in the circumferential direction;

FIGS. 8 and 9 show the same views as FIGS. 2 and 3, however of a second exemplary embodiment of the invention, comprising a hold-down bracket that is offset in the circumferential direction;

FIG. 10 shows the same view as FIG. 4, however with a hold-down spring shown in a sectional view;

FIG. 11 shows the upper portion of FIG. 10, however in an enlarged scale; and

FIG. 12 shows the same view as FIG. 4, however on the left side in the partial load state and on the right side without hold-down bracket and in the relaxed state.

### DETAILED DESCRIPTION

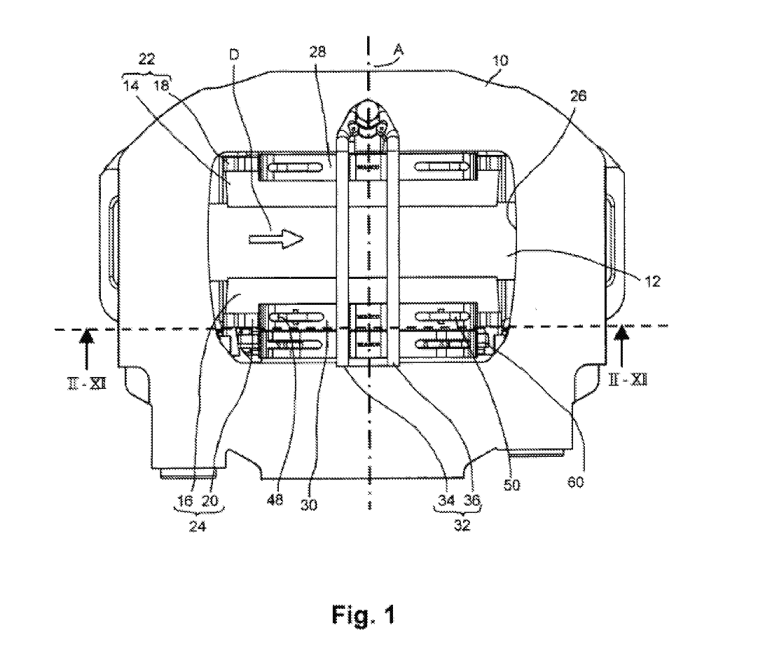

FIG. 1 shows a top view onto one exemplary embodiment of the disk brake according to the invention comprising a brake caliper 10, which surrounds a brake disk 12. Brake pads 22, 24 composed of a friction lining 14, 16 and metallic backing plate 18, 20 are disposed axially displaceably along an axis A of the brake disk in shaft guides on both sides of the brake disk so as to be activated during a braking process by way of a brake application device disposed in the brake caliper 10 and not shown here. The brake pads 22, 24 here are guided or supported both radially inwardly and also in the circumferential direction by shaft guides of the brake. The brake caliper 10 has a radial opening/installation opening 26 for installing/removing the brake pads 22, 24. The preferred direction of rotation of the brake disk 12 during forward travel is indicated by an arrow D. This direction of rotation also applies to the following figures.

As was already described above, each brake pad 22, 24 is assigned a hold-down spring 28, 30 in the form of a leaf spring, which is mounted on the upper end region of the backing plate. The mounting is described in greater detail hereafter. A hold-down bracket 32, which comprises two rods 34, 36, is attached to the brake caliper 10. The attachment is achieved by way of anchoring and a screw connection, for example. The hold-down bracket 32 tensions and positions the brake pads 22, 24 in the frame or U-shaped shaft guide.

The following descriptions refer to sections II-XII from FIG. 1, wherein the corresponding backing plate 20 is mounted in a partial cutout of the shaft guide and is tensioned therein by way of the hold-down bracket 32 and the hold-down spring 30.

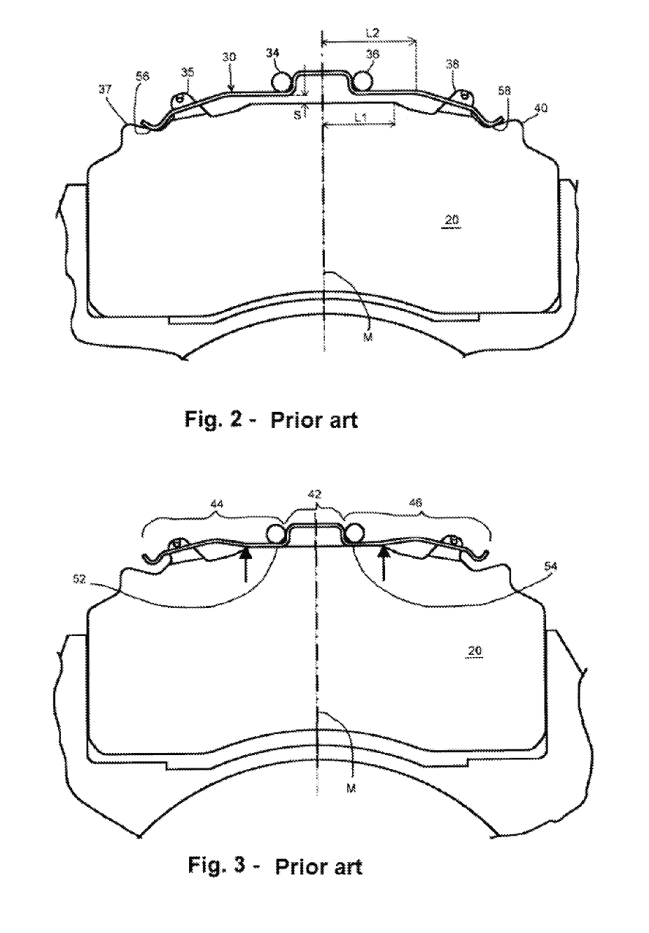

FIG. 2 shows a backing plate 20 of the type in question according to the prior art in the installation position with a hold-down spring 30 in the partial load range. In the center of the upper edge region, the backing plate 20 has a substantially flat region, which then extends in an obliquely sloping manner at an angle on both side regions. Two projections 35, 37 and 38, 40 protrude in each case on both sides of a central axis M and outside the flat region.

As can be seen in particular from FIG. 3, the hold-down spring 30—like all other hold-down springs—comprises a central region 42, which extends radially outwardly between the two rods 34, 36 of the hold-down bracket 32, and two spring legs 44, 46. The radial extension of the central region for the form-locked connection essentially matches the dimensions of the hold-down bracket.

The two centric projections 35, 38 are used to mount the hold-down spring 30 and extend in through openings (FIG. 1) 48, 50 of the two spring legs 44, 46. The two outer projections 37, 40 are used as contact bearings for the corresponding ends of the lateral spring legs 44, 46.

The two spring legs 44, 46 in each case have a first region 52, 54, against which a rod 34, 36 of the hold-down device 32 is seated in a hold-down manner, and a second region 56, 58, which is seated against the brake pad 20 or against the respective outer projection 37, 40 in a hold-down manner.

Since both the brake pad 20 and the hold-down spring 30 are designed symmetrically with respect to the central axis M, only the right side will be analyzed in FIGS. 2 and 3 hereafter for the sake of simplicity.

The flat region of the upper side of the backing plate 20 extends over a length L₁. This contour of the backing plate also remains unchanged by the hold-down spring newly created by the invention.

The radially extending portion of the hold-down spring 30, which forms the boundary region between the central region 42 and the spring leg 46, together with the portion of the spring leg 46 adjoining the same, forms approximately an L-shaped bearing surface for the rod 36 of the hold-down bracket 32. The radial protuberance of the central region 42 thus engages in the hold-down bracket 32 in a form-locked manner. Under partial load, the hold-down spring 30 acts radially on the backing plate 20. The hold-down spring 30 is thus fixed in the circumferential direction of the brake disk 12 on the stationary hold-down bracket 32.

In the partial load range according to FIG. 2, the spring leg 46 has an approximately flat region having the length L₂, which protrudes over the above-mentioned flat region having the length L₁ of the backing plate 20 in the direction of the second region 58. Adjoining thereon, the spring leg extends in an obliquely sloping manner at an angle toward the curved second region 58. Depending on the installation position and operating state of the brake—the spring leg 46 can thus be elastically supported on the abutment taper (contact region) of the outer projection 40.

The hold-down spring 30 is coupled to the backing plate 20 in the axial direction of the brake disk 12 as a result of the two inner projections 35, 38 engaging in the through openings 48, 50.

Because the curved second region 58 of the spring leg 46 acts on the edge region of the backing plate 20, necessary damping can be generated in the partial load range, for example, across the entire length of the spring leg.

To ensure that, during normal driving operation, relatively free radial mobility of the backing plate 20 is preserved without loss of the spring action across the extension of the spring, a distance S is maintained between the first regions 52, 54 of the spring legs 44, 46 on the other hand and the backing plate 20 on the other hand, the distance in cooperation with a planar progression of the backing plate 20 in the central region, and a corresponding progression of the hold-down spring 30 in this region, making so-called radial functional play possible. In other words, both the hold-down spring 30 and the backing plate 20 are held in such a way that the backing plate 20 is able to move radially outward toward the hold-down spring 30, and more particularly within the scope of the above-mentioned radial functional play.

In particular on poor road sections, extreme conditions with accelerations of up to 26 g may occur. If the backing plate 20 thereupon lifts off the lower shaft guide, it strikes against the first regions 52, 54 of the spring legs 44, 46. As a result of the positions of the regions having the lengths L₁ and L₂ shown in FIG. 2, the backing plate 20 acts with a secondary lever arm having the length L₁ and generates a corresponding secondary moment in the spring leg. Since the contact point at the end of L₁ is located laterally from the hold-down bracket 32 (shown with arrows in FIG. 3), the second region (the end) 56, 58 of the spring leg 44, 46 is lifted off the contact seat on the backing plate 20. As a result, the spring action is lost across the entire leg length. Additionally, material impairment of the hold-down spring 30, such as deformation, destruction and the like, may occur during the fast and frequent change from the partial load to the full load range.

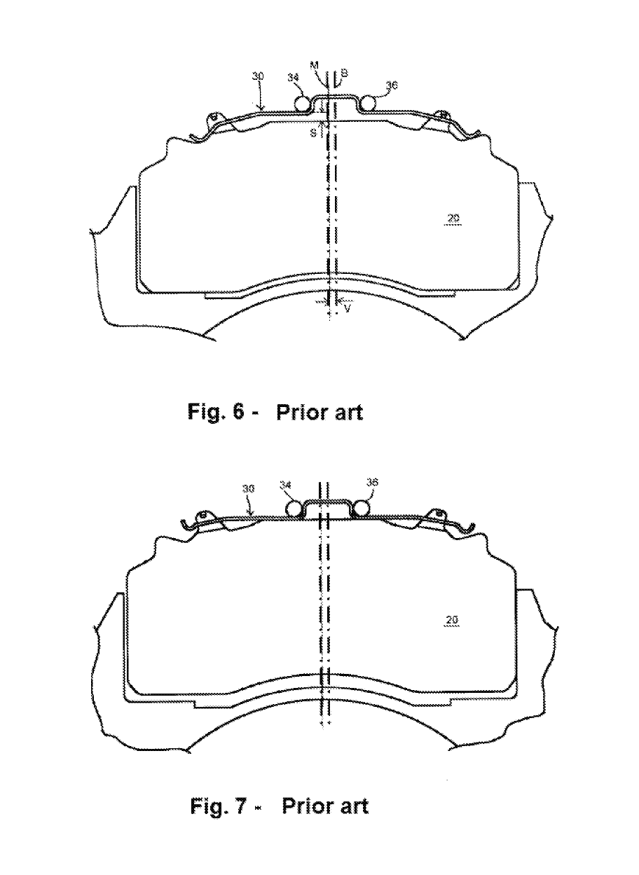

Additional shear and compressive strains occur in the bearing regions (L-shaped transition region), in particular when, in accordance with FIGS. 6 and 7, the hold-down bracket 30 is disposed with eccentric mounting in the direction of the brake disk exit side during forward travel with respect to the other two parts in the brake caliper so as to additionally generate a tangential spring preload on the brake pad via the hold-down spring 30. These extreme load change states can result in material fatigue. An offset axis is denoted by B, and the offset is denoted by V.

According to the invention, the L-shaped immediate transition region is missing compared to the conventional spring contour. It is replaced by a longitudinally acting mounting for the hold-down bracket that is located lower than at the beginning of the spring leg and designed as a combined mounting/sliding region. As a result of the shape as an (elongated) depression or as a trough, the beginning of the spring leg is relocated to the radial outside. In addition, a relaxation zone for relieving/reducing disadvantageous strains is introduced or generated in the transition region between the lateral radial projection in the central region and at the beginning of the spring leg. For this purpose, the width of the depression or of the trough is slightly larger than the cross-sectional region of the hold-down bracket located in this region.

This new shape of the hold-down spring results in multiple advantages, in particular in the full load range, which is to say after the functional play S is overcome, which are apparent from FIGS. 5 and 9 (without or with eccentricity of the hold-down bracket).

If the brake pad is displaced toward radial outward as a result of the above accelerations, the upper edge region of the backing plate 20 strikes against the first region 52, which compared to the pivotable portion of the spring leg is located radially further inward. It has a depression- or trough-shaped design and forms a mounting region for the hold-down bracket 32 or for a rod 34, 36 of the hold-down bracket 32. Since the upper edge region of the backing plate 20 has contact with the spring leg 44, 46 outside the first region 52, 54 and is therefore not able to raise it or lever it out, no loss of contact occurs between the second region 56, 58 (spring leg end) and the outer projection 37, 40 of the backing plate 20, even under these extreme conditions. As a result, the full spring action is preserved. Moreover, no material deformation can occur any longer because the backing plate 20 no longer has contact with the spring leg outside the described regions. A disadvantageous secondary lever arm as in the prior art cannot develop any more.

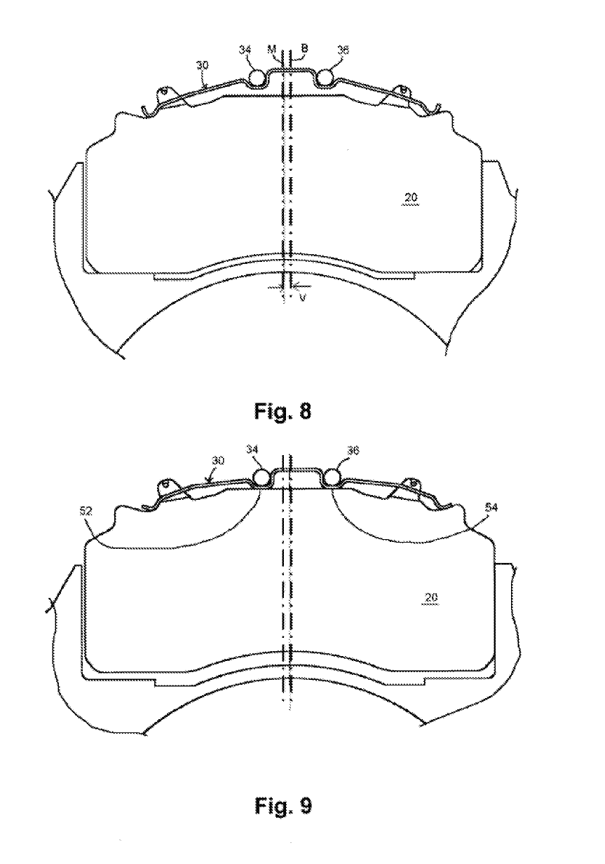

This spring design creates additional advantages, especially in the case of an offset of the hold-down bracket 32 according to FIGS. 8 and 9 for generating an additional tangential preload.

If reversing braking occurs against the preferred braking direction with lateral movements of the brake pad in the shaft guide, so that the brake pad strikes laterally against a shaft wall, the spring leg 46 thus displaced can become seated against the corresponding rod of the hold-down bracket (here, the right rod 36) via the depression/trough contour. In other words, it is compressed thereagainst. Upon release of the brake via this relative form-locked connection, the leg is able to generate an improved, additional shear action via the portion of the hold-down bracket on this side. In this way, the displaced spring leg can be better relieved at the end of the braking process, so as to tension the brake pad not only radially, but again tangentially (in the circumferential direction) into the correct shaft position. Moreover, shear and compressive strains are again absorbed or warded off via the trough structure. According to the prior art, this preloading occurred solely from the deforming L-shaped transition region.

The new spring shape can be successfully used, in particular both with a centric and with an eccentric installation position of the hold-down bracket in the brake caliper with the resulting spring preloads such as radial, or radial and tangential, against the brake pad and the guide shaft thereof.

FIG. 10 shows a sectional view of the hold-down spring 30, so that it is apparent that the length X2 of the opening 50 is greater than the length X1 of the projection 38. While this is shown only on the right side of FIG. 10, it also applies to the left side, which is symmetrical in this regard.

As a result of the above-described differences in the lengths X1 and X2, the hold-down spring 30 can be stretched or compressed, depending on the operating state, without being impaired in the corresponding movements by the projections 35, 38. In other words, the projections 35, 38 do not strike against the narrow-side walls of the openings 48, 50. The spring action is thus always impressed at the end sides of the spring legs—which is to say behind the projections 35, 38, as seen looking from the center—which is contrary to the teaching of DE 698 16 175 T2.

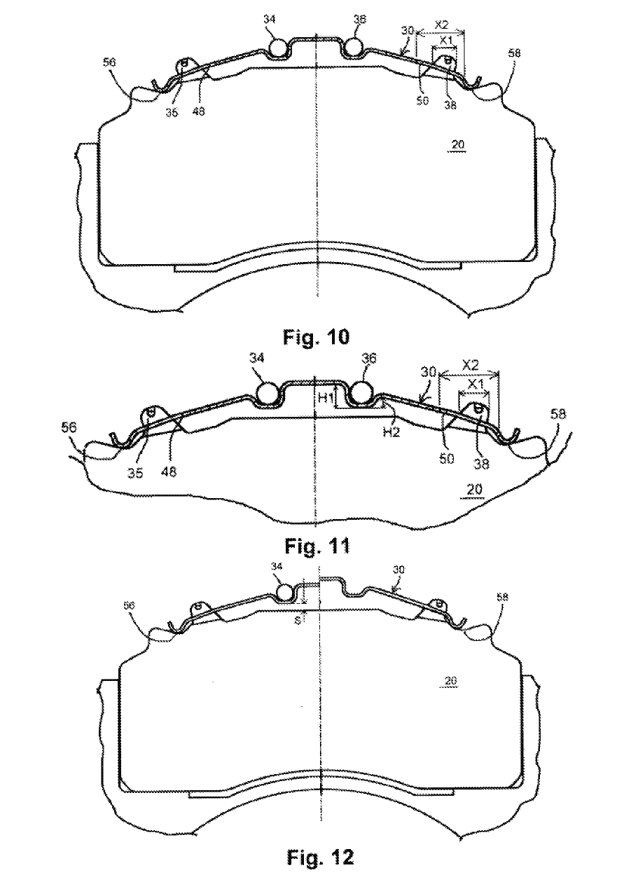

FIG. 11 clearly shows that the hold-down spring 30 surrounds the hold-down bracket 34, 36 in a trough-shaped manner. However, the walls of the respective trough are not symmetrical. The wall height H1 on the central region corresponds approximately to the diameter of the hold-down bracket, while the wall height 112 on the other side is just about half as large. The respective spring leg, and in particular the free end thereof, thus has sufficient freedom of movement to meet the requirements of the individual load cases.

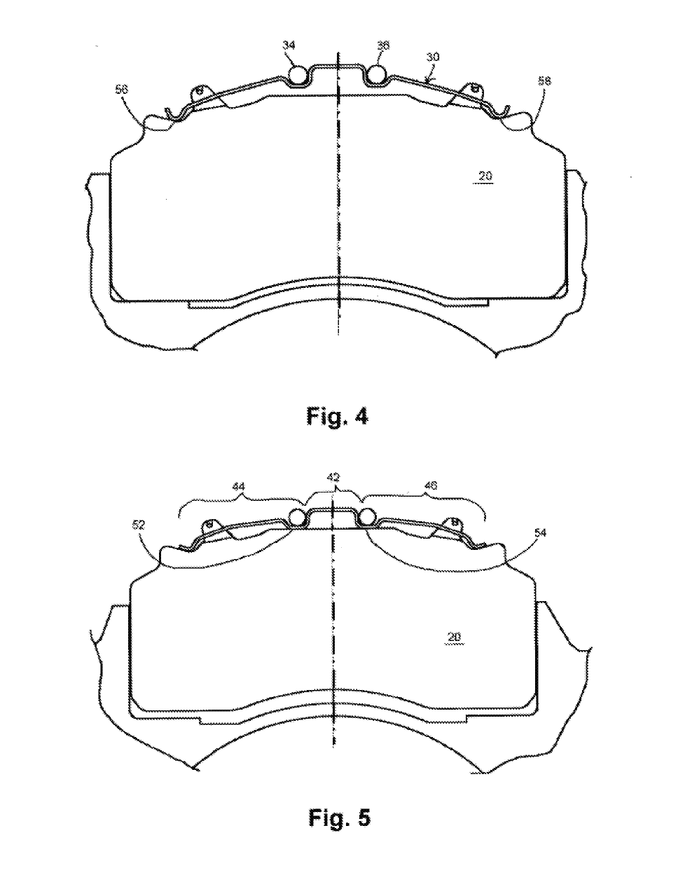

FIG. 12 shows a synopsis of two spring states. The state under partial load corresponding to the illustration of FIG. 4 is shown to the left of the center line. The state without the hold-down bracket is shown in the relaxed state to the right of the center line. According to FIG. 12, the lateral extension of the hold-down spring 30 is shorter and higher in the relaxed state, which is to say it is curved more strongly, than if it were tensioned by way of the hold-down bracket, and is displaced in the direction of the outer contour of the backing plate under partial load.

Although the new spring contour was described based on a backing plate, it shall be noted that according to the invention it can be used not only primarily for this purpose, but also in separate pressure plates or pressure distribution plates, namely when such a pressure plate is used with spring preload in disk brakes between the brake application device and the brake pad on this side. Such a pressure plate is denoted by the reference numeral 60 in FIG. 1.

The above-mentioned distance, from which the functional play S results, must be suitably selected in keeping with the remaining circumstances. It depends in particular on the size of the brake and the braking forces that are to be expected. For example, in brakes for wheels having a rim size of 17 to 25″, the distance is at least 2 to 4 mm.\

The characteristics of the invention disclosed in the above description, in the claims and in the drawings may be essential for the implementation of the invention in its various embodiments either alone or in any arbitrary combination with each other.

1. A disk brake, comprising:
a pressing device, which is pressed against a brake disk (12) for braking;
a hold-down spring in a form of a leaf spring, which holds down the pressing device;
a hold-down bracket, which comprises two rods (34, 36) and preloads the hold-down spring against the pressing device,
wherein the hold-down spring
is designed symmetrically with respect to the transverse plane thereof and comprises two spring legs and a central region between the two spring legs, which extends radially outward (in a form-locked manner) between the two rods of the hold-down bracket,
the two spring legs having a respective opening into which in each case a projection (35, 38) extends on the pressing device,
wherein each of the spring legs comprises:
a first region, against which a respective rod of the hold-down bracket rests in a hold-down manner, and
a second region, which rests against the pressing device in a hold-down manner, and
the first regions of the spring legs being held at a distance (S) from the pressing device in the rest state,
characterized in that the spring legs initially extend radially outwardly from the first region to the second region.

2. The disk brake according to claim 1, characterized in that the hold-down spring surrounds the two rods of the hold-down bracket in each case in a trough-shaped manner, wherein the two first regions of the spring legs form the respective base of the trough.

3. The disk brake according to claim 1, characterized in that the second regions in each case are located at least partially on the sides of the openings which face away from the first regions.

4. The disk brake according to claim 1, characterized in that the openings are longer than the projections.

5. The disk brake according to claim 1, characterized in that the hold-down spring, when installed, is offset with respect to the pressing device in the circumferential direction of the brake disk.

6. The disk brake according to claim 1, wherein the hold-down spring is
designed symmetrically and comprises two spring legs and a central region between the two spring legs, which when installed extends radially outward between two rods of the hold-down bracket,
the two spring legs having a respective opening into which in each case, when installed, a projection extends on the pressing device,
wherein each of the spring legs comprises:
a first region, against which when installed a respective rod of the hold-down bracket rests in a hold-down manner, and
a second region, which when installed rests against the pressing device in a hold-down manner,
the first regions of the spring legs, when installed, being held at a distance from the pressing device in the rest state, and
the spring legs initially extending radially outwardly from the first region to the second region.

7. The hold-down spring according to claim 6, characterized by surrounding the two rods of the hold-down bracket in each case in a trough-shaped manner when installed, wherein the two first regions of the spring legs form the respective base of the trough.

8. The hold-down spring according to claim 6, characterized in that the second regions in each case are located at least partially on the sides of the openings which face away from the first regions.

9. A hold-down spring according to claim 6, characterized in that the openings are longer than the projections.
